(19) United States
(12) Patent Application Publication
(10) Pub. No.: US 2011/0084956 A1
(43) Pub. Date: Apr. 14, 2011

(54) LIQUID CRYSTAL DISPLAY DEVICE

(76) Inventors: Byung Jin CHOI, Gumi-si (KR); Oh Hyun LEE, Gimcheon-si (KR)

(21) Appl. No.: 12/881,795

(22) Filed: Sep. 14, 2010

(30) Foreign Application Priority Data
Oct. 6, 2009 (KR) 10-2009-0094728

(51) Int. Cl. G09G 5/00; G09G 3/36

(52) U.S. Cl. 345/212; 345/211; 345/87

(57) ABSTRACT

Disclosed is a LCD device that includes a liquid crystal panel; a driving circuit including data and gate drivers, a timing controller to control the data and gate drivers, and a first power supplier to apply a first driving voltage to the data and gate drivers and the timing controller; a backlight unit disposed at the rear of the liquid crystal panel and including an LED array provided with a plurality of LEDs, an LED driver to apply driving signals to the LED array, and a second power supplier to apply a second driving voltage to the LED driver; and a printed circuit board connected to one edge of the liquid crystal panel and defined into first and second domains which are combined with each other.

### CROSS-REFERENCE TO RELATED APPLICATION

This application claims priority under 35 U.S.C. 119 to Korean Patent Application No. 10-2009-0094728, filed on Oct. 6, 2009, which is hereby incorporated by reference in its entirety.

### BACKGROUND

1. Field of the Disclosure

This disclosure relates to a liquid crystal display (LCD) device.

2. Description of the Related Art

In general, the LCD device is based on an image realizing principle employing optical isotropic and polarization properties of the liquid crystal. The optical isotropic property enables liquid crystal molecules with a thin and long shape to be directionally aligned. The polarization property forces a direction of the liquid crystal molecular alignment to be controlled in accordance with an electric field applied to the liquid crystal.

More specifically, the LCD device includes a liquid crystal panel, a driving circuit, and backlight unit. The liquid crystal panel includes two substrates combined opposite each other in the center of a liquid crystal layer, and transparent electrodes formed on the opposite surfaces of the two substrates and used to generate an electric field. Such an LCD device artificially controls the direction of the liquid crystal molecular alignment by regionally adjusting the intensity of an electric field using the driving circuit, thereby inducing transmittance differences between regions of the liquid crystal panel. Then, the LCD device allows light emitted from the backlight unit to pass through the liquid crystal panel, so that an image in accordance with the transmittance differences between the regions is visibly revealed. In this way, the LCD device can display a variety of desired images.

FIG. 1 is a block diagram schematically showing the configuration of an ordinary LCD device. As shown in FIG. 1, the ordinary LCD device includes a liquid crystal panel 10, a driving circuit 20 configured to control a liquid crystal panel 10, and a backlight unit 40 configured to apply light to the liquid crystal panel 10.

The backlight unit 40 includes a plurality of light emission diodes (LEDs). The LED, as a spot light source, has a high speed response characteristic. As such, the LED can effectively be applied to video signal stream and driven in an impulsive mode. Also, the LED is actively used as a light source of the backlight unit because brightness and chromaticity can be arbitrarily changed by controlling the light quantity of each of red, green, and green LEDs.

However, a white LED capable of emitting white light has not been developed up to the present. Due to this, the backlight unit 40 is configured to include red, green, and blue LEDs, in order to generate white light. In addition, the backlight unit must include LED driving circuit for driving the red, green, and blue LEDs because driving power variations in accordance with chromatic levels depend differently upon the red, green, and blue LEDs.

If the LCD device is used for a small-sized appliance, such as a cellular phone, the LED driving circuits are mounted on a printed-circuit-board (PCB) with the panel driving circuit, in order to make the LCD device slimmer. In this case, a driving voltage for the panel driving circuit is subjected to noise interference caused by another driving voltage for the LED driving circuit. This results from the fact that there is a large difference between the driving voltages which are used to drive the LED and panel driving circuit loaded on the same PCB, respectively.

### BRIEF SUMMARY

Accordingly, the present embodiments are directed to a backlight unit that substantially obviates one or more of problems due to the limitations and disadvantages of the related art, and an LCD device with the same.

An object of the present embodiments is to provide an LCD device that is adapted to minimize noise interference.

Additional features and advantages of the embodiments will be set forth in the description which follows, and in part will be apparent from the description, or may be learned by practice of the embodiments. The advantages of the embodiments will be realized and attained by the structure particularly pointed out in the written description and claims hereof as well as the appended drawings.

According to one general aspect of the present embodiment, an LCD device includes: a liquid crystal panel; a driving circuit configured to include data and gate drivers which are connected to drive the liquid crystal panel, a timing controller which is formed to control the data and gate drivers, and a first power supplier which is formed to apply a first driving voltage to the data and gate drivers and the timing controller; a backlight unit disposed at the rear of the liquid crystal panel and configured to include an LED array which is provided with a plurality of LEDs, an LED driver which is formed to apply driving signals to the LED array, and a second power supplier which is formed to apply a second driving voltage to the LED driver; and a printed circuit board connected to one edge of the liquid crystal panel and defined into first and second domains which are combined with each other. Wherein, at least one part of the driving circuit is disposed in the first domain of the printed circuit board, and at least one part of the backlight unit is disposed in the second domain of the printed circuit board.

The first and second domains of the printed circuit board can be electrically insulated from each other.

The first and second domains of the printed circuit board can be connected to each other by means of balls.

The first domain of the printed circuit board can be loaded with the timing controller and first power supplier which are included in the driving circuit. On the other hand, the second domain of the printed circuit board can be loaded with the LED driver and second power supplier which are included in the backlight unit.

The printed circuit board defined into the first and second domains can be formed by preparing a bared printed-circuited-board, cutting the bared printed-circuit-board into two parts which each have the sizes of the first and second domains, and combining the two parts.

The first driving voltage generated from the first power supplier on the first domain can have about 5V, and the second driving voltage generated from the second power supplier on the second domain can have about 24V.

The data driver is mounted on one edge of the liquid crystal panel through a first COF (chip on film), and the gate driver is mounted on another edge of the liquid crystal panel through a second COF.

The first COF can be connected to the first domain of the printed circuit board.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the embodiments and are incorporated in and constitute a part of this application, illustrate embodiment(s) of the invention and together with the description serve to explain the disclosure. In the drawings:

FIG. 1 is a block diagram schematically showing the configuration of an ordinary LCD device;

FIG. 2 is a planar view showing an LCD device according to an embodiment of the present disclosure;

FIG. 3 is a block diagram showing the LCD device according to an embodiment of the present disclosure;

FIG. 4 is an enlarged planar view showing in detail the PCB in FIG. 2;

FIG. 5A is a graphic diagram showing noise interference generated in the ordinary LCD device; and

FIG. 5B is a graphic diagram showing noise interference generated in the LCD device according to an embodiment of the present disclosure.

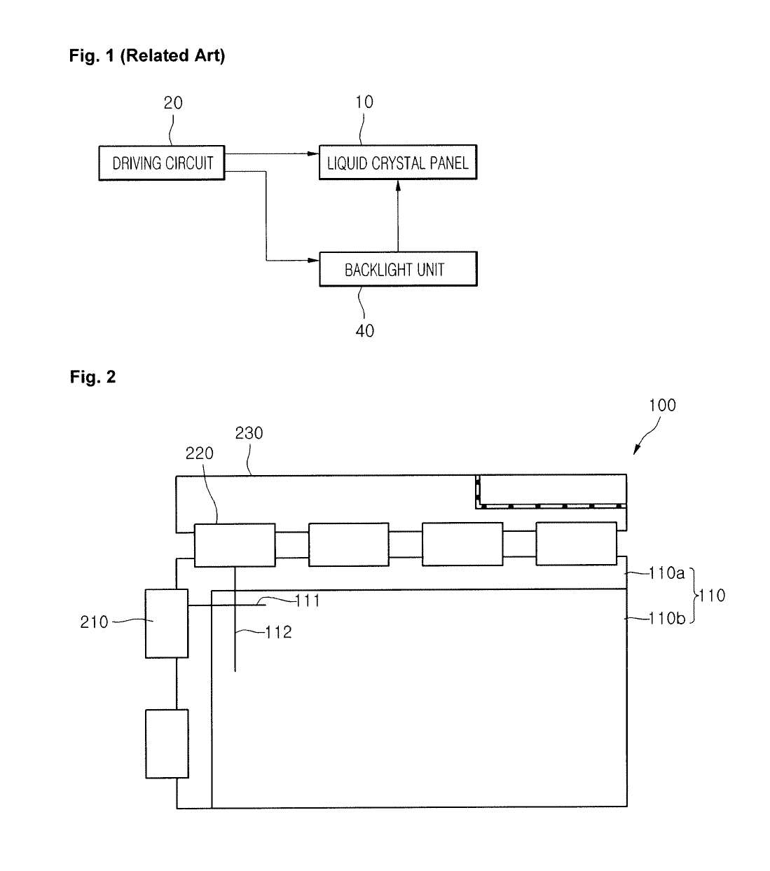

### DETAILED DESCRIPTION

Reference will now be made in detail to the embodiments of the present disclosure, examples of which are illustrated in the accompanying drawings. These embodiments introduced hereinafter are provided as examples in order to convey their spirits to the ordinary skilled person in the art. Therefore, these embodiments might be embodied in a different shape, so are not limited to these embodiments described here. Also, the size and thickness of the device might be expressed to be exaggerated for the sake of convenience in the drawings. Wherever possible, the same reference numbers will be used throughout this disclosure including the drawings to refer to the same or like parts.

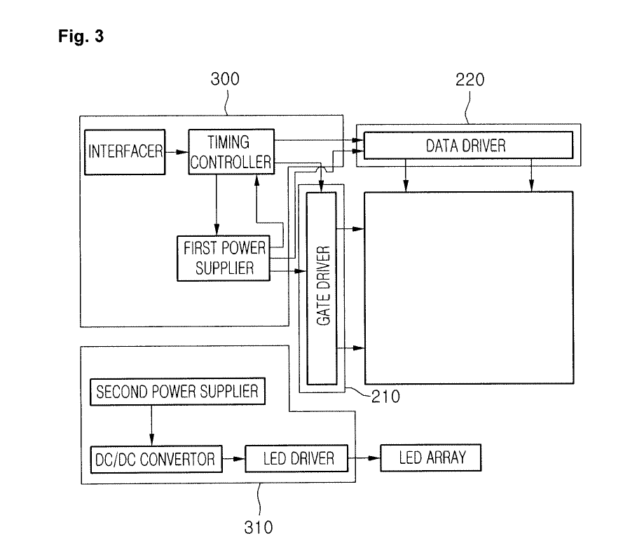

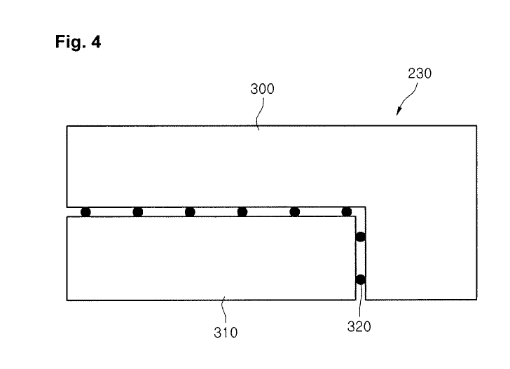

FIG. 2 is a planar view showing an LCD device according to an embodiment of the present disclosure. FIG. 3 is a block diagram showing the LCD device according to an embodiment of the present disclosure.

As shown in FIGS. 2 and 3, an LCD device 100 includes a liquid crystal panel 110 defined into a display area and a non-display area, a driving circuit configured to provide driving and data signals necessary to drive the liquid crystal panel 110, and a backlight unit (not shown) disposed in a backward direction of the liquid crystal panel 110 and configured to radiate light to the liquid crystal panel 110. The display area is actually used to display images, but the non-display area is not used to display images.

The liquid crystal panel 110 includes first and second substrates 110a and 110b combined to maintain a fixed gap (or space) therebetween, and a liquid crystal layer (not shown) interposed between the two substrates 110a and 110b. On the first substrate (or a thin film transistor substrate) 110a, a plurality of gate lines 111 are arranged at a first fixed interval and along a first direction, and a plurality of data lines 112 are arranged at a second fixed interval and along a second direction perpendicular to the first direction. The plurality of gate lines 111 and the plurality of data line 112 cross each other and define pixel regions which are arranged in a matrix shape. The first substrate 110a further includes a pixel electrode and a thin film transistor which are formed in each of the pixel regions. The thin film transistor responds to a signal on the respective gate line 111 and selectively switches another signal which is transferred from the respective data line 112 to the respective pixel electrode. On the other hand, the second substrate (or the color filter substrate) 110b includes a black matrix (not shown) formed to shield light which is radiated to the rest of the first substrate 110a without the pixel regions, color filter layers (not shown) formed to realize color schemes, and a common electrode (not shown) used to implement images. The color filter layers include red, green, and blue color filter layers (not shown).

Such first and second substrates 110a and 110b are separated from each other by the fixed gap (or space) by means of spacers (not shown). Also, the first and second substrate 110a and 110b are combined with each other by means of a sealant. Then, a liquid crystal material is injected between the combined substrates 110a and 110b, thereby forming a liquid crystal layer between the two substrates 110a and 110b.

The backlight unit not shown in the drawings includes an LED array 240 configured to include a plurality of LEDs (not shown), an LED driver 314 configured to generate signals necessary to drive the LEDs, and a first power supplier 312 configured to apply necessary voltages to the LED driver 314. The plurality of LEDs are arranged at a third fixed interval along row and column directions. The LED driver 314 included in the backlight unit controls an amount of current quantity flowing through each of the LEDs included in the backlight unit, in order to adjust light quantity of each LED. To this end, the LED driver 314 includes a DC-DC (direct current-direct current) converter (not shown) configured to convert a DC voltage into a bias voltage for the LED and to apply the converted voltage to an electrode of each LED.

The driving circuit includes an interfacer 302 connected to an external system (not shown), a data driver 222 configured to apply data signals to the data lines 112 on the liquid crystal panel 110, a gate driver 212 configured to apply scan signals to the gate lines 111 on the liquid crystal panel 110, and a timing controller 304 connected to the interfacer 302 and configured to receive control signals and image data from the external system via the interfacer 302. The timing controller 304 controls the gate driver 212 and data driver 222 using the control signals and transfers the image data to the data driver 222. Also, the driving circuit further includes a second power supplier 306 configured to generate necessary voltages for the liquid crystal panel 110, gate driver 212, data driver 222, interfacer 302, and timing controller 304. The second power supplier 306 can be controlled by the timing controller 304.

The data driver 222 included in the driving circuit is connected to one edge of the non-display area of the liquid crystal panel 110 in such a manner as to be mounted on second COFs (Chip On Films or Chip On Flexible printed-circuit-boards) 220. Similarly, the gate driver 212 included in the driving circuit is connected to another edge of the non-display area of the liquid crystal panel 110 in such a manner as to be mounted on first COFs 210.

The first and second COFs 210 and 220 each loaded with the gate driver 212 and the data driver 222 can be replaced with TCPs (Tape Carrier Packages) or FPCs (Flexible Printed Circuit Boards). In another different manner, the data driver 222 and/or the gate driver 212 can be formed in a COG (Chip On Glass). The second COFs 220 loaded with the data driver 222 are connected to a printed circuit board 230.

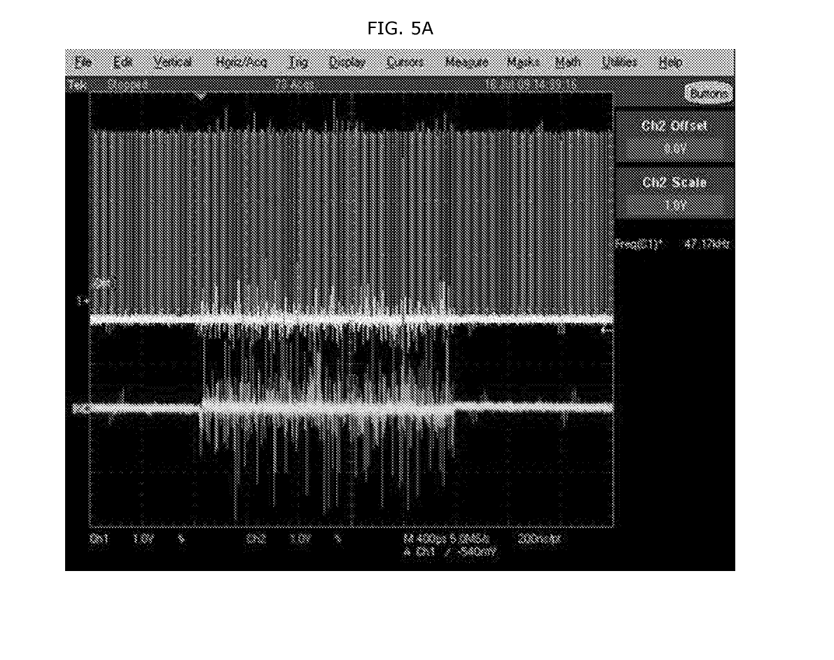

The printed circuit board 230 is loaded with parts of the driving circuit and parts of the backlight unit. To this end, the printed circuit board 230 is divided into first and second domains 300 and 310 connected to each other by balls 320, as shown in FIG. 4.

In order to manufacture the printed circuit board 230, one bare printed circuit board is first provided. The provided board is cut into two parts, thereby obtaining two board pieces each corresponding to the sizes of first and second domains 300 and 310. Then, the divided board pieces are combined with each other in a single surface by means of the balls 320, so that the printed circuit board 230 defined into the first and second domains 300 and 310 is completed, as shown in FIG. 4.

Referring to FIG. 3, the interfacer 302, timing controller 304 and second power supplier 306, which are included in the driving circuit, are arranged on the first domain 300 of the printed circuit board 230. On the other hand, the first power supplier 312 and LED driver 314, which are included in the backlight unit, are arranged on the second domain 310 of the printed circuit board 300.

The second power supplier 306 on the first domain 300 applies a first driving voltage of 5V to the gate driver 212, data driver 222, timing controller 304 and interfacer 302. The first power supplier 312 on the second domain 310 applies a second driving voltage of 24V to the LED driver 314.

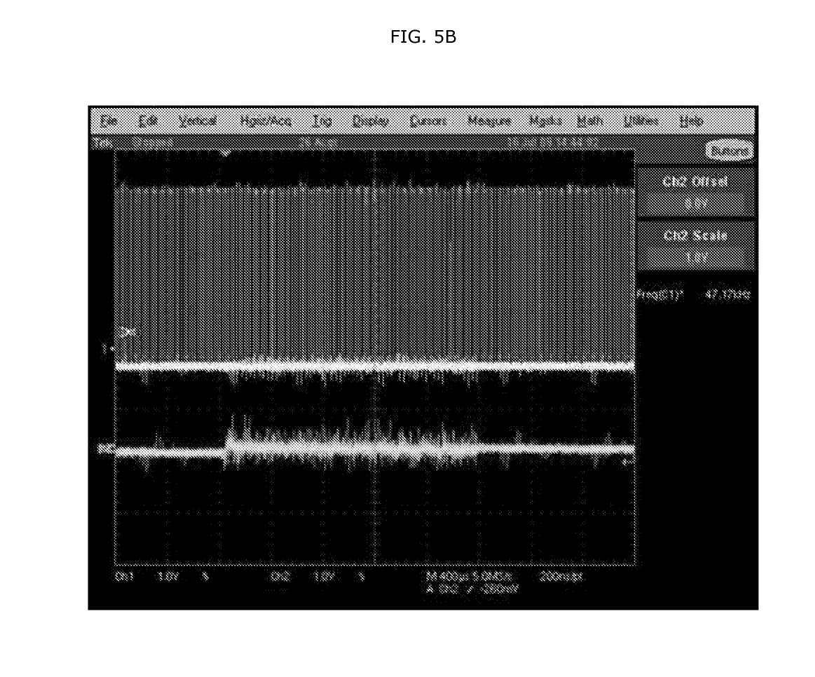

In this manner, a voltage difference between the first and second driving voltages output from the first and second power suppliers 312 and 306 is very large. Nevertheless, if the driving circuit and the LED driver 314 the backlight unit are arranged on the same printed circuit board, the second driving voltage output from the second power supplier 306 is subjected to noise interference caused by the first driving voltage which is output from the first power supplier 312, as a bottom waveform shown in FIG. 5A.

In a different manner, the LCD device of the present embodiment forces the components of the driving circuit and the LED driver 314 of the backlight unit to be arranged on the first and second domains 300 and 310 of the printed circuit board 230 electrically isolated. Therefore, the second driving voltage output from the second power supplier 306 is rarely subjected to noise interference caused by the first driving voltage from the second power supplier 312, as a bottom waveform shown in FIG. 5B.

As seen from FIGS. 5A and 5B, it is evident that noise interference is greatly reduced when the driving circuit and the LED driver 314 of the backlight unit are arranged on one printed circuit board with two electrically insulated domains rather than the ordinary single printed circuit board.

Although a preferable embodiment has been described in detail with reference to an illustrative embodiment, it should be understood that numerous other modifications and embodiments can be devised by those skilled in the art that will fall within the spirit and scope of the principles of this disclosure. For example, if necessary, at least three groups of components which are each driven by at least three driving voltage with level differences can be distinguishably arranged on at least three domains of the printed circuit board electrically insulated. In this case, the lower driving voltages are rarely subjected to noise interference caused by the higher driver voltages. Therefore, variations and modifications in the component parts and/or arrangements, alternative uses must be regarded as included in the appended claims.

What is claimed is:

1. A liquid crystal display device comprising:
a liquid crystal panel;
a driving circuit configured to include data and gate drivers which are connected to drive the liquid crystal panel, a timing controller which is formed to control the data and gate drivers, and a first power supplier which is formed to apply a first driving voltage to the data and gate drivers and the timing controller;
a backlight unit disposed at the rear of the liquid crystal panel and configured to include an LED array which is provided with a plurality of LEDs, an LED driver which is formed to apply driving signals to the LED array, and a second power supplier which is formed to apply a second driving voltage to the LED driver; and
a printed circuit board connected to one edge of the liquid crystal panel and defined into first and second domains which are combined with each other,
wherein at least one part of the driving circuit is disposed in the first domain of the printed circuit board, and at least one part of the backlight unit is disposed in the second domain of the printed circuit board.

2. The liquid crystal display device claimed as claim 1, wherein the first and second domains of the printed circuit board are electrically insulated from each other.

3. The liquid crystal display device claimed as claim 1, wherein the first and second domains of the printed circuit board are connected to each other by means of balls.

4. The liquid crystal display device claimed as claim 1, wherein the first domain of the printed circuit board is loaded with the timing controller and first power supplier which are included in the driving circuit.

5. The liquid crystal display device claimed as claim 1, wherein the second domain of the printed circuit board is loaded with the LED driver and second power supplier which are included in the backlight unit.

6. The liquid crystal display device claimed as claim 1, wherein the printed circuit board defined into the first and second domains is formed by
preparing a bared printed-circuited-board;
cutting the bared printed-circuit-board into two parts which each have the sizes of the first and second domains; and
combining the two parts.

7. The liquid crystal display device claimed as claim 1, wherein the two parts is connected to each other by means of balls in such a manner as to be in a single plane.

8. The liquid crystal display device claimed as claim 1, wherein the first driving voltage generated from the first power supplier on the first domain has about 5V, and the second driving voltage generated from the second power supplier on the second domain has about 24V.

9. The liquid crystal display device claimed as claim 1, wherein the data driver is mounted on one edge of the liquid crystal panel through a first COF (chip on film), and the gate driver is mounted on another edge of the liquid crystal panel through a second COF.

10. The liquid crystal display device claimed as claim 9, wherein the first COF is connected to the first domain of the printed circuit board.
